(19) United States
(12) Patent Application Publication
(10) Pub. No.: US 2011/0008475 A1
(43) Pub. Date: Jan. 13, 2011

(54) USE OF AN EMULSION OF MINT OIL OR OF L-CARVONE FOR THE FUNGICIDAL TREATMENT OF FRUIT, VEGETABLES OR PLANTS

(76) Inventor: Alberto Sardo, Chateaurenard (FR)

Correspondence Address: JACOBSON HOLMAN PLLC, 400 SEVENTH STREET N.W., SUITE 600, WASHINGTON, DC, 20004, US

(21) Appl. No.: 12/742,015

(22) PCT Filed: Nov. 10, 2008
(86) PCT No.: PCT/FR2008/052021

§ 371 Date: Sep. 24, 2010

(30) Foreign Application Priority Data
Nov. 9, 2007 (FR) 07 58917

(51) Int. Cl. A01N 65/22; A01N 35/06; A01P 3/00

(52) U.S. Cl. 424/747; 514/690

(57) ABSTRACT

The present invention relates to novel emulsions of mint oil and/or L-carvone and the use thereof for the fungicidal treatment of field crops or products thereof.

The present invention relates to a method for the fungicidal treatment of field crops to decontaminate them from or inhibit contamination by a fungus.

Field crops are subject to fungal infection in the field or during storage following harvesting. This applies in particular to potatoes, which may be infected by the Rhizoctonia solani fungus. This causes black scurf and develops from black sclerotia attached to the parent tuber or present in the soil. Tubers from affected plants are small, misshapen and angular. Contamination by Rhizoctonia solani usually occurs in the field and develops during storage. It is therefore important to use a fungicidal treatment in the field and after harvesting.

The potato is also subject to silver scurf (Helminthosporium solani). Phytophthorae are also very widespread, for example cabbage, lettuce, chicory and strawberry plant mildew (Peronospora brassicae).

It is therefore desirable to have novel, improved fungicidal treatments available, particularly of natural origin, presenting no danger to consumers.

The use of L-carvone for the anti-germinating treatment of potatoes has been described (see in particular application EP 0 719 499). Further, the fungicidal activity of L-carvone in vitro has also been described by Goris et al., Brighton Crop Protection Conference, Pest and Disease, 1994, 307-312). However, this article only describes experimental tests on a laboratory scale which are not necessarily indicative of the industrial scale. Moreover, the essential mint oil is used in a pure form, by evaporation, and the article does not suggest any improved formulation compositions.

It is therefore advantageous to make available new formulations of mint oil or L-carvone for carrying out the fungicidal crop treatment method.

Thus, the present inventors have developed a formulation of L-carvone or mint oil in emulsion, in the presence of lecithin and/or derivatives.

According to the first object, the present invention therefore relates to a fungicidal crop treatment method comprising the application of mint oil and/or L-carvone in emulsion in water.

Preferably, said treatment is carried out at ambient temperature.

Preferably, said emulsion comprises one or more lecithins and/or derivatives.

According to a preferred aspect, the method according to the invention aims to decontaminate or prevent contamination by Rhizoctonia such as Rhizoctonia solani or mildew. Preferably, the mildew parasite is a Phytophthora or Peronospora, such as Phytophthora infestans or Peronospora brassicae.

The method according to the invention is particularly advantageous for the fungicidal treatment of potatoes, cabbages, chicory and strawberry plants.

In general, said composition can be applied by any means known per se, in particular by spraying or via irrigation water, in the fields or during storage to harvested fruit, vegetables, bulbs or tubers.

The method according to the invention comprises the steps of:

i. diluting a concentrated emulsifiable formulation of L-carvone and/or mint oil in water
and
ii. applying the emulsion thus obtained to the field crops to be treated.

Preferably, said concentrated emulsifiable formulation can be diluted in water in a ratio of between 1% and 90%, for example in irrigation water. The concentration depends on the plants to be treated as well as the strength of the fungicidal action. These adjustments form part of routine operations which are conventionally carried out. Thus, for example, for crops which are sensitive to phytotoxicity (cabbage, strawberry plant), it is preferred to make use of emulsions diluted to 30-90%. For more resistant species (potatoes, chicory), a concentration of between 1 and 30% may be sufficient.

It is also possible to adjust the concentration of lecithin and/or derivatives to reduce the phytotoxicity of the fungicidal compositions, by altering the lecithin/L-carvone ratio. In fact, surprisingly, lecithin and/or derivatives reduce the phytotoxicity of terpenes.

According to another object, the present invention further relates to a concentrated emulsifiable concentration comprising
5% to 80% mint oil and/or L-carvone;
2% to 70% lecithin(s) or derivative(s);
0% to 40% vegetable oil(s);
0% to 40% non-ionic surfactant(s);
0% to 40% other terpene(s).

In a first embodiment, the ratio by weight of lecithin(s) and/or derivative(s) to mint oil and/or L-carvone is greater than or equal to 1 by weight.

Thus, said formulation comprises:
10% to 70% soy lecithin;
5% to 40% mint oil and/or L-carvone;
0% to 40% vegetable oil(s);
0% to 40% non-ionic surfactant(s);
0% to 40% other terpene(s);
   and more preferably:
approximately 20% mint oil and/or L-carvone;
approximately 40% soy lecithin;
approximately 20% vegetable oil;
approximately 20% non-ionic surfactants; and/or
approximately 0% other terpenes.

In another embodiment, said formulation is such that the ratio of lecithin(s) and/or derivative(s) to mint oil and/or L-carvone by weight is less than 1.

Said formulation then comprises:
2% to 40% lecithin(s) or derivative(s);
10% to 80% mint oil and/or L-carvone;
0% to 40% vegetable oil(s);
0% to 40% non-ionic surfactant(s);
0% to 40% other terpene(s);
   and more preferably:
approximately 20% lecithin(s) or derivative(s);
approximately 45% mint oil and/or L-carvone;
approximately 15% vegetable oil(s);
approximately 20% non-ionic surfactants(s);
approximately 0% other terpenes.

Said non-ionic surfactant(s) are generally of the ethoxylated oleic acid type.

It is advantageous for said lecithin(s) and/or derivative(s) to be selected from lecithins of natural origin (egg, soya), optionally hydrolysed.

According to another object, the present invention further relates to the method for the fungicidal treatment of field crops comprising the application of a concentrated emulsifiable formulation as defined above.

Generally, one litre of formulation is applied per one tonne of plants.

Carvone refers to 2-methyl-5-(1-methylethenyl)-2-cyclohexen-1-one. Unlike D-carvone, of which the principal natural source is cumin, and other oxygenated monoterpenes, L-carvone is a compound which is naturally ingested in large quantities in human nutrition, for example when consuming some mint-based dishes or when chewing gum, its main natural source being spearmint or Mentha spicata. L-carvone may be obtained from natural sources, in particular spearmint (Mentha spicata) or by synthesis from limonene. The development of an effective fungicidal treatment using a product widely consumed in nutrition as the active ingredient meets current needs for non-toxic treatments.

“Field crops” refers to plants or plant products intended for consumption, in particular fruit, vegetables, bulbs and tubers.

The expression “fungicidal treatment” refers to decontamination from or prevention of contamination by fungus, particularly mildew. “Mildew” is the generic name for a range of plant diseases caused by fungi. The term “mildew” is applied to the following parasites: Plasmopara viticola, which infects vines, Plasmopara helianthi (sunflower mildew), Phytophthora infestans, which affects potatoes, Phytophthora cactorum (or fragariae), which infects strawberry plants, Phytophthora capsici (pear mildew), Peronospora brassicae (cabbage), Peronospora destructor (onion, garlic), Hyaloperonospora parasitica (crucifers such as cabbage), Peronospora pisi (field or garden pea), Peronospora spinaciae (spinach), Peronospora tabacina (tobacco), Pseudoperonospora cubensis (gourd mildew), Pseudoperonospora humuli (hop mildew), and Bremia lactucae, which infects lettuces and artichokes.

The various surfactants or emulsifying agents are known per se. According to the present invention, a surfactant means any type of agent conventionally used as an emulsifying agent, such as ethoxylated fatty acids, ethoxylated fatty alcohols, long-chain ethoxylated alcohols, ethoxylated alkylphenols or any other non-ionic product. Examples of non-ionic surfactants which can be used according to the invention are in particular the condensation product of an aliphatic fatty acid, preferably C₈-C₂₂, with a C₂-C₃ alkylene oxide. The C₂-C₃ alkylene oxide may be ethylene oxide, propylene oxide or even a mixture of ethylene oxide and propylene oxide in any proportions. An example of surfactants of this type is the condensation product of lauric acid (or n-dodecyl alcohol) with 30 mol ethylene oxide.

The surfactants according to the invention may also comprise other agents conventionally used in the treatment of fruit, vegetables or tubers. The non-ionic surfactants include in particular sucro-esters, ethoxylated sorbitan monooleates, ethoxylated fatty acids, esterified fatty acids such as glycerine oleate and mixtures thereof, ethoxylated fatty acids, and ethoxylated fatty alcohols.

Any terpenes are suitable as terpenes, preferably non-oxygen-containing terpenes, such as pinenes and limonene, more particularly limonene.

Possible vegetable oils are in particular edible oils such as sunflower oil, maize oil, peanut oil and olive oil.

The lecithins are mixtures of combinations of esters of oleic, stearic and palmitic acid with glycerophosphoric acid and choline. “Lecithin” refers to lecithins and/or their derivatives. This expression encompasses one or more compounds selected from the compounds of phosphatidylcholine distearyl, palmityl and/or oleyl and/or their derivatives such as phosphatidylinositol, phosphatidyl thanolamine and/or phosphatidic acid and/or mixtures thereof. The lecithins and/or derivatives are preferably of natural origin, for example from egg yolk, E322 or soya (soy lecithin). The lecithin derivatives include in particular lysolecithins and/or derivatives: these compounds are the result of eliminating a fatty acid from the lecithins and/or derivatives mentioned above, such as Emultop HL50®, sold by Degussa. The lecithins and/or derivatives comprising at least one lysolecithin and/or derivatives are soluble in vegetable oils: thus, the compositions according to the invention make it possible to use products of natural origin only.

The presence of lecithins is particularly advantageous because it makes it possible to reduce the evaporation of the active ingredient.

Compositions are prepared by mixing the components according to a method known per se. To carry out the method according to the invention, the composition may be applied at a temperature of between 15° and 45°, preferably at ambient temperature.

The following are given as non-limiting illustrative examples of the present invention.

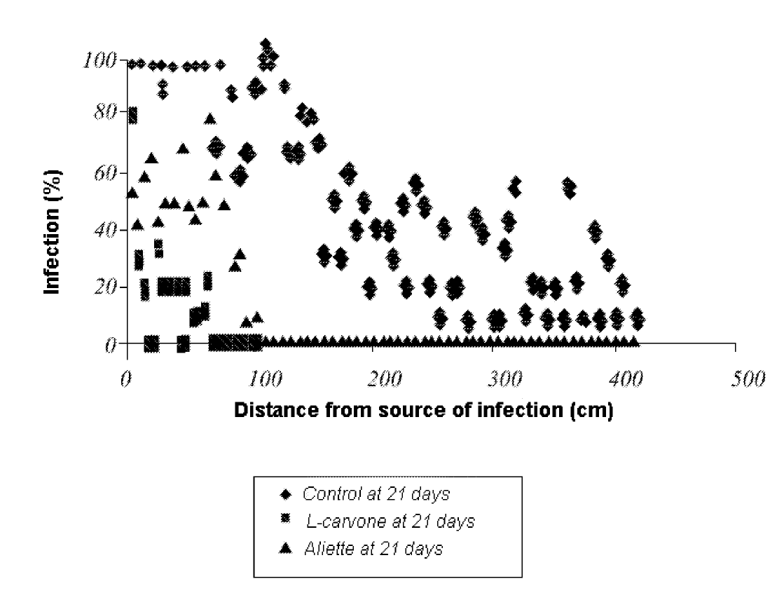

FIG. 1 shows the effectiveness of L-carvone on infection by cabbage mildew.

### EXAMPLES

### Effect of L-Carvone on Cabbage Mildew

Cabbages were infected with Peronospora brassicae (cabbage mildew) then treated rapidly after inoculation with L-carvone or Aliette.

L-carvone, applied at a minimal concentration of 1%, was able to control the infection effectively for 21 days, unlike Aliette, as can be seen from FIG. 1.

1-25. (canceled)

26. Method for the fungicidal treatment of field crops or products of field crops comprising the application of an emulsion comprising mint oil and/or L-carvone in water, at ambient temperature.

27. Method according to claim 26, wherein the field crops or products of field crops are selected from fruit, vegetables, bulbs or tubers.

28. Method according to claim 26, wherein said emulsion further comprises one or more lecithins and/or derivatives thereof.

29. Method according to claim 26, wherein said fungicidal treatment comprises decontamination from or prevention of contamination by a rhizoctonia or mildew.

30. Method according to claim 29, wherein said rhizoctonia is Rhizoctonia solani.

31. Method according to claim 30, wherein the mildew parasite is a Phytophthora or Peronospora.

32. Method according to claim 31, wherein said parasite is Phytophthora infestans or Peronospora brassicae.

33. Method according to claim 26, wherein the treated plants are selected from potato, cabbage, chicory and strawberry plants.

34. Method according to claim 26, wherein said composition is applied by spraying or via irrigation water.

35. Method according to claim 26, wherein the method is carried out in the fields.

36. Method according to claim 26, wherein said treatment is carried out on harvested fruit, vegetables, bulbs or tubers during storage.

37. Method according to claim 26, wherein said method comprises the steps of:
i. diluting in water a concentrated emulsifiable formulation comprising:
5% to 80% mint oil and/or L-carvone;
2% to 70% lecithin or derivative thereof;
0% to 40% vegetable oil;
0% to 40% non-ionic surfactant;
0% to 40% other terpene
and
ii. applying the emulsion thus obtained to the field crops to be treated.

38. Method according to claim 37, wherein said concentrated emulsifiable formulation is diluted in water in a ratio of between approximately 1% and 90%.

39. Method according to claim 37, wherein said concentrated emulsifiable formulation is diluted in irrigation water.

40. Concentrated emulsifiable formulation comprising:
5% to 80% mint oil and/or L-carvone;
2% to 70% lecithin or derivative thereof;
0% to 40% vegetable oil;
0% to 40% non-ionic surfactant;
0% to 40% other terpene.

41. Formulation according to claim 40, wherein the ratio by weight of lecithin and/or derivative thereof to mint oil and/or L-carvone is greater than or equal to 1.

42. Formulation according to claim 40, wherein said formulation comprises:
10% to 70% soy lecithin;
5% to 40% mint oil and/or L-carvone;
0% to 40% vegetable oil;
0% to 40% non-ionic surfactant;
0% to 40% other terpene.

43. Formulation according to claim 40, wherein said formulation comprises:
approximately 20% mint oil and/or L-carvone;
approximately 40% soy lecithin;
approximately 20% vegetable oil;
approximately 20% non-ionic surfactants; and/or
approximately 0% other terpenes.

44. Formulation according to claim 40, wherein the ratio of lecithin and/or derivative thereof to mint oil and/or L-carvone by weight is less than 1.

45. Formulation according to claim 40, comprising:
2% to 40% lecithin or derivative thereof;
10% to 80% mint oil and/or L-carvone;
0% to 40% vegetable oil;
0% to 40% non-ionic surfactant; and
0% to 40% other terpene.

46. Formulation according to claim 40, comprising:
approximately 20% lecithin and/or derivative thereof;
approximately 45% mint oil and/or L-carvone;
approximately 15% vegetable oil;
approximately 20% non-ionic surfactant;
approximately 0% other terpenes.

47. Formulation according to claim 40, wherein said non-ionic surfactant is of the ethoxylated oleic acid type.

48. Formulation according to claim 40, wherein said lecithin and/or derivative thereof is selected from lecithins of natural origin, optionally hydrolysed.

49. Method for the fungicidal treatment of field crops or products of field crops comprising the application of a concentrated emulsifiable formulation according to claim 40.

50. Method according to claim 24, wherein one litre of the formulation is applied per one ton of plants.
